(19) United States
(12) Patent Application Publication
(10) Pub. No.: US 2026/0064628 A1
(43) Pub. Date: Mar. 5, 2026

(54) REDUCED-SIZE FILE TYPE CLASSIFICATION WITH DEEP LEARNING

(71) Applicant: Palo Alto Networks, Inc., Santa Clara, CA (US)

(72) Inventors: Tung-Ling Li, Fremont, CA (US); Dongrui Zeng, Sunnyvale, CA (US); Wenjun Hu, Santa Clara, CA (US); Yang Ji, San Jose, CA (US); William Redington Hewlett, II, Mountain View, CA (US)

(21) Appl. No.: 18/821,695

(22) Filed: Aug. 30, 2024

(51) Int. Cl. G06F 16/11; G06F 16/174

(52) U.S. Cl. CPC G06F 16/11; G06F 16/1744

(57) ABSTRACT

Files are classified by file type based on reduced-size representations of the file contents (e.g., truncated versions of files) using a trained convolutional neural network (CNN). The CNN architecture includes a hidden layer comprising a Kolmogorov-Arnold Network (KAN) layer in lieu of a traditional fully connected layer. Training of the CNN employs a cost function that combines cross-entropy loss and contrastive loss for evaluating CNN performance. Training of the CNN is also incremental-when training a CNN for the task of classifying reduced-size files, the CNN is first trained on a training dataset comprising files of their original sizes. Once this initial phase of training is complete, the trained CNN is fine-tuned as a result of one or more additional phases of training, where each additional training phase uses a training dataset comprising reduced-size (e.g., truncated) versions of the files.

### BACKGROUND

The disclosure generally relates to data processing (e.g., CPC subclass G06F) and to computer systems based on specific computational models (e.g., CPC subclass G06N).

A convolutional neural network (CNN) is a type of deep learning model specifically designed for processing structured grid data, such as images. CNNs employ convolutional layers that apply a set of filters to the input data, which provides for learning of spatial hierarchies of features from low to high levels of abstraction. CNNs typically include layers such as convolutional, pooling, and fully connected layers. This architecture is particularly advantageous in image recognition, natural language processing, and other tasks involving large-scale, high-dimensional data.

Kolmogorov-Arnold Networks (KANs) are specialized neural networks based on the Kolmogorov-Arnold representation theorem, which asserts that any multivariate continuous function can be decomposed into a finite sum of continuous, univariate functions. In contrast with multilayer perceptrons (MLPs), KANs have learned activation functions as weights on network edges rather than linear weights or activation functions on nodes of the network. KANs have been presented as an alternative to traditional MLPs that can achieve efficient computation and greater interpretability with smaller architectures.

Malicious scripts are scripts that comprise malicious program code. Malicious scripts can be distributed with different file types, such as comma-separated value (CSV) files and files comprising program code written in the Python® programming language, among others. Malware detection logic for detecting malicious scripts may differ across script types.

### BRIEF DESCRIPTION OF THE DRAWINGS

Embodiments of the disclosure may be better understood by referencing the accompanying drawings.

FIG. 1 is a conceptual diagram of classifying reduced-size files by type based on utilizing a CNN trained to classify files of reduced sizes.

FIG. 2 is a conceptual diagram of training a CNN to classify files of reduced sizes by type.

FIG. 3 is a flowchart of example operations for training a CNN to classify reduced-size files by type.

FIG. 4 is a flowchart of example operations for determining performance of a CNN being trained to classify files by type with a combined cost function.

FIG. 5 is a flowchart of example operations for classifying reduced-size files by type with a trained CNN.

FIG. 6 depicts an example computer system with a reduced-size file classification service and a reduced-size file classifier trainer.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Many malware detection techniques for detecting malicious files rely on the file extensions to inform their types, which in turn informs the malware detection logic that is applicable to each file depending on its type. This is particularly the case for scripts, where malware detection uses logic that is specifically designed for analysis of scripts. However, classifying files by type based on their file extensions alone can be unreliable, as file extension names associated with files may be changed regardless of the file contents. Disclosed herein are lightweight techniques for classification of files by type based on reduced-size versions of the file contents using a trained CNN. File classification is referred to as lightweight because the CNN is trained to classify files based on the reduced-size versions thereof. Reduced-size versions of files can be versions of files comprising the first N bytes of each file (e.g., the first 1500 or 3000 bytes of a file) such that the CNN classifies truncated versions of files.

The CNN architecture varies from conventional CNN architecture in that it includes a hidden layer comprising a KAN layer in lieu of a traditional fully connected layer. Additionally, training of the CNN employs a cost function that combines cross-entropy loss and contrastive loss for evaluating CNN performance. Training of the CNN is incremental such that file classification is lightweight without sacrificing accuracy. When training a CNN for the task of classifying reduced-size files, the CNN is first trained on a training dataset comprising files of their original sizes. Once this initial phase of training is complete, the trained CNN is fine-tuned as a result of one or more additional phases of training, where each additional training phase uses a training dataset comprising reduced-size (e.g., truncated) versions of the files. Experimental results of file type classification using a CNN that is trained in this manner demonstrate that files of multiple types that have been truncated to their first 1500 or 3000 bytes can be classified with an average latency of 0.5 milliseconds and with average classification accuracies exceeding 99% across file types.

### Example Illustrations

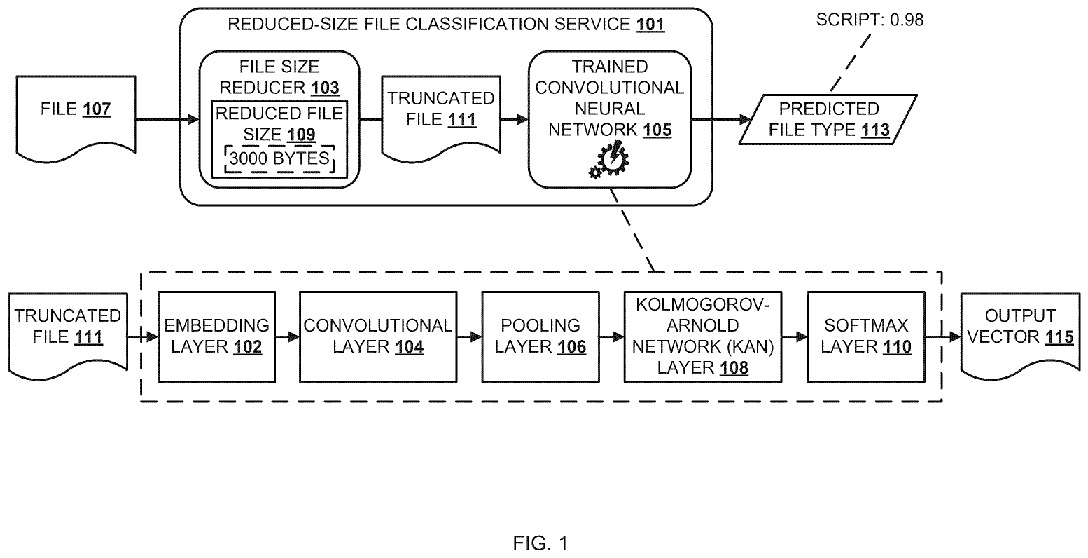

FIG. 1 is a conceptual diagram of classifying reduced-size files by type based on utilizing a CNN trained to classify files of reduced sizes. A reduced-size file classification service (“service”) 101 classifies files according to their predicted type (e.g., document, script, image, etc.). The service 101 may execute as part of a cybersecurity appliance, such as a hardware or software firewall or as a cloud-based service, such as a cloud-based service that communicates with a cybersecurity appliance. Files designated for classification by type are passed to the service 101. To illustrate, files detected by a firewall can be provided to the service 101 for classification. Predicting type of a file through classification with the service 101 can inform a file type-specific malware detector to which the file should be passed and/or an action a firewall should take on the file, among other examples.

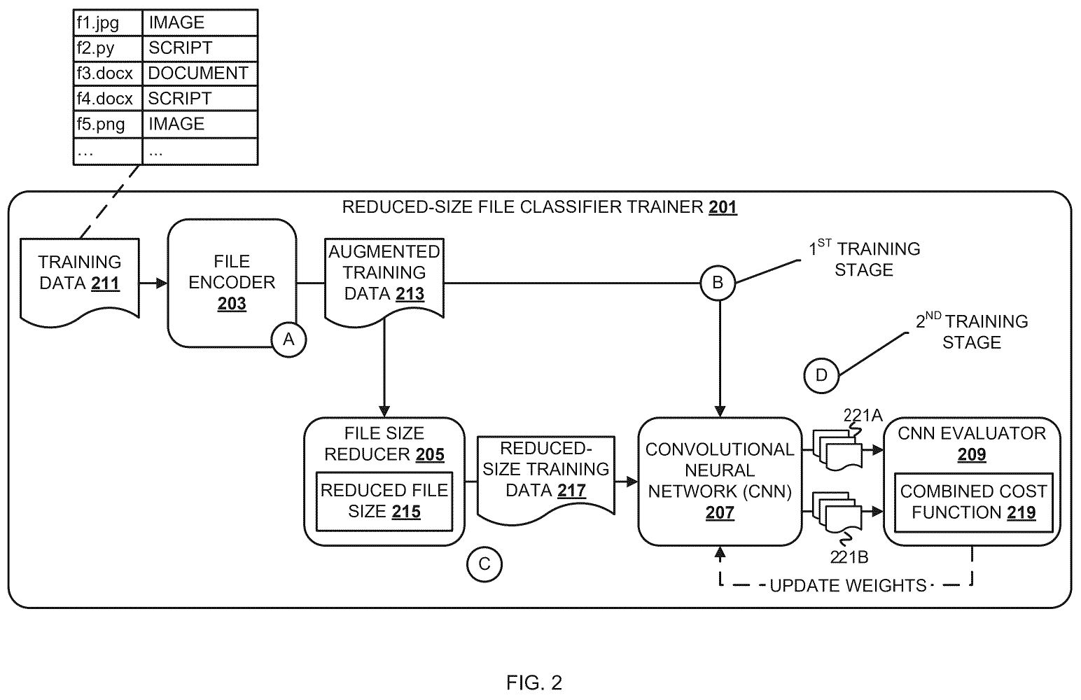

The service 101 comprises or has access to a trained CNN 105. As will be described in further detail in reference to FIG. 2, the trained CNN 105 has been trained to classify reduced-size (e.g., truncated) files provided as input as corresponding to one of a plurality of file types. Examples of file types on which the trained CNN 105 has been trained for classification include scripts, documents, and images, among others. FIG. 1 depicts the architecture of the trained CNN 105 in further detail. The trained CNN 105 comprises an embedding layer 102, a convolutional layer 104, a pooling layer 106, a KAN layer 108, and a softmax layer 110. The trained CNN 105 is not limited to these layer types and may comprise additional layers in implementations but should at least comprise these layers. The pooling layer 106 can be a max pooling layer, such as a global max pooling layer. The KAN layer 108 is a hidden layer traditionally used in KANs. The KAN layer 108 provides the advantage that different activation functions (i.e., learnable activation functions on edges) can be used across features rather than one fixed activation function for all features, which increases the degree of learning that can be achieved at this layer.

FIG. 1 depicts an example in which a file 107 of unknown type is provided to the service 101. A file size reducer 103 of the service 101 truncates the file 107 to a designated size with which it has been configured, depicted as reduced file size 109. The file size reducer 103 can first generate a copy of the file 107 before truncating the file 107 to maintain the original, full-size version of the file; in other examples, a copy of the file 107 has already been created before it is passed to the service 101. In this example, the reduced file size 109 indicates a size of 3000 bytes such that the file size reducer 103 truncates files designated for classification to their first 3000 bytes. The file size reducer 103 thus truncates the file 107 (or copy thereof) to its first 3000 bytes to generate a truncated file 111. Bytes of the file 107 that are not included in the truncated file 111 can be discarded. The reduced file size 109 of 3000 bytes is used as an illustrative example, and implementations are not limited to truncating files to their first 3000 bytes.

The service 101 inputs the truncated file 111 into the trained CNN 105. The trained CNN 105 processes the truncated file 111 to determine its predicted class, which is indicated in an output vector 115 output by the trained CNN 105. The output vector 115 indicates probabilities that the truncated file 111 (and thus the file 107) corresponds to each of the plurality of possible file types. The service 101 determines and indicates a predicted file type 113 of the file 107 based on the output vector 115. The predicted file type 113 indicates the file type having a maximum probability in the output vector 115. The service 101 can further indicate the associated probability with the predicted file type 113. In this example, the predicted file type 113 indicates that the file 107 is predicted to be a script file with a 0.98 probability. Subsequent analysis or other processing of the file 107 can thus be performed with functionality specifically designed for script analysis/processing, such as with a malware analyzer designed to analyze script files for malware.

Numbers of neurons in each layer of the trained CNN 105 are not depicted in FIG. 1 since exact neuron counts in each layer can vary among implementations. Generally, the numbers of neurons per layer for one or more of the layers of the trained CNN 105 and/or filters of the convolutional layer can vary depending on whether the service 101 executes on a hardware appliance (e.g., a hardware cybersecurity appliance) or virtually/in a cloud (e.g., as a cloud-based service), as the trained CNN 105 may be smaller in size in terms of memory capacity/storage requirements when installed on a hardware appliance. As an illustrative example, the convolutional layer of the trained CNN 105 can comprise N filters in an implementation deployed to a hardware appliance and 2N filters in an implementation deployed to the cloud, such as 128 and 256 filters, respectively. The KAN layer of the trained CNN 105 can also comprise a small number of neurons (e.g., 32 neurons). This can impact the size to which files are reduced in implementations as well as the reduced file size for which the trained CNN 105 has been trained. The file size reducer 103 can be configured with a designated size for file reduction that is appropriate for the environment in which the service 101 is executing. For instance, the file size reducer 103 may truncate files to their first N bytes when the service executes in a hardware environment and to their first M bytes when the service executes in a cloud, where N<M. The trained CNN 105 thus has been trained to classify files truncated to their first N bytes for the former case and has been trained to classify files truncated to their first M bytes for the latter case. This reflects hardware limitations of hardware appliances and allows the service 101 to execute with consideration for these limitations, thus diversifying the potential deployment environments for the service 101.

FIG. 2 is a conceptual diagram of training a CNN to classify files of reduced sizes by type. FIG. 2 depicts an example of training a CNN that results in the trained CNN 105 of FIG. 1. A reduced-size file classifier trainer (“classifier trainer”) 201 trains a CNN 207 that has the architecture depicted in FIG. 1. The CNN 207 is initially instantiated with this architecture and a default set of weights at the commencement of training. The classifier trainer 201 trains the CNN 207 based on a set of training data 211. The training data 211 includes a plurality of files of various types, where files included in the training data 211 have been labelled by their respective type. FIG. 2 depicts the training data 211 as comprising two image files named “f1.jpg” and “f5.png”, two script files named “f2.py” and “f4.docx”, and a document file named “f3.docx”. As demonstrated in this example with the file “f4.docx”, actual file types in terms of their contents may not necessarily correspond to the file extension indicated in the file names, as these can be changed.

FIG. 2 is annotated with a series of letters A-D. Each letter represents a stage of one or more operations. Although these stages are ordered for this example, the stages illustrate one example to aid in understanding this disclosure and should not be used to limit the claims. Subject matter falling within the scope of the claims can vary from what is illustrated.

At stage A, a file encoder 203 of the classifier trainer 201 encodes at least a subset of the files included in the training data 211 to generate augmented training data 213. The file encoder 203 can select N of the files in the training data 211 to encode, such as by randomly selecting a set of N files and encoding each of the N files. The file encoder 203 encodes the subset of files in the training data 211 according to one or more encoding algorithms or standards, such as by generating Base64 encoded and/or UTF-8 encoded versions of each file in the subset to be encoded. The file encoder 203 adds the encoded files to the training data 211 to yield augmented training data 213, which includes the files of the training data 211 and the encoded files that have been generated.

At stage B, the classifier trainer 201 completes a first training stage for the CNN 207. The classifier trainer 201 inputs the augmented training data 213 into the CNN 207 and obtains corresponding outputs 221A, each of which indicates a probability vector comprising probabilities of the respective file corresponding to each of a set of possible types. The classifier trainer 201 comprises a CNN evaluator 209 that evaluates performance of the CNN 207 based on a combined cost function 219 and updates weights of the CNN 207 accordingly. The combined cost function 219 combines (e.g., averages or sums) cross-entropy loss and contrastive loss for error computation. The CNN evaluator 209 computes cross-entropy loss based on predicted and actual file types corresponding to each of the outputs 221A. The CNN evaluator 209 also obtains vectors output by a pooling layer of the CNN 207 for contrastive loss calculation. The CNN evaluator 209 computes contrastive loss based on measuring distance between vectors output by the pooling layer of the CNN 207 that correspond to the same and different file types to determine distances therebetween. Generally, files of the same types should result in similar numerical vectors being output by the pooling layer, while files of different types should result in substantially different numerical vectors output by the pooling layer. Similarity of numerical vectors output by the pooling layer is measured with a distance function (e.g., cosine similarity or Euclidean distance) as part of contrastive loss calculation. Contrastive loss is employed so that the CNN 207 is penalized for generating relatively similar vectors at the pooling stage for different file types and thus learns that different file types should have substantially different vectors resulting from pooling.

Whether the CNN evaluator 209 updates the weights of the CNN 207 based on error computed with the combined cost function 219 after obtaining each of the outputs 221A (i.e., after each file type prediction is output by the CNN 207), after each training epoch, or after obtaining batches of the outputs 221A can vary among implementations depending on the techniques employed for weight updating (e.g., the gradient descent technique being utilized with backpropagation). The first training stage is complete when the termination criterion has been satisfied for training the CNN 207 on the augmented training data 213. The termination criterion can be a criterion that cost computed for the CNN 207 with the combined cost function 219 is reduced (e.g., is below a threshold), that a designated number of training epochs have been completed, etc.

At stage C, a file size reducer 205 of the classifier trainer 201 generates a set of reduced-size training data 217 from the augmented training data 213. The file size reducer 205 reduces size of each of the files in the augmented training data 213 to a reduced file size 215 with which it has been configured. For instance, the file size reducer 205 can truncate each of the files in the augmented training data 213 to the size specified by the reduced file size 215, such as by truncating file contents to their first N bytes (assuming a reduced file size 215 having a value of N) and including these truncated file contents in the reduced-size training data 217. The reduced-size training data 217 comprises reduced-size versions of the files in the augmented training data 213 and their corresponding labels.

At stage D, the classifier trainer 201 completes a second training stage(s) for the CNN 207. The classifier trainer 201 trains the CNN 207 further, but this time uses the reduced-size training data 217. This further trains the CNN 207 to classify files of reduced sizes by type. Training of the CNN 207 on the reduced-size training data 217 is performed similar to training of the CNN 207 on the augmented training data 213 as describe at stage B, where the CNN evaluator 209 computes error of the CNN 207 using the combined cost function 219 based on probability vectors obtained as outputs 221B by the CNN 207 and actual file types (for cross-entropy loss) and based on vectors output by the pooling layer of the CNN 207 (for contrastive loss), with weights of the CNN 207 updated based on the computed error. Further details that are redundant are omitted for brevity. The second training stage is complete when the termination criterion has been satisfied for training the CNN 207 on the reduced-size training data 217. The termination criterion can be a criterion that cost computed for the CNN 207 with the combined cost function 219 is minimal (e.g., is below a threshold), that a designated number of epochs have been completed, etc. This training criterion need not be the same as the training criterion used during the first training event as described at stage B. The CNN 207 can then be deployed for classification of files in a deployment environment as described above in reference to FIG. 1.

While not depicted in FIG. 2 for simplicity, implementations can complete another training stage for the CNN 207 after completion of the second training stage with another set of reduced-size training data generated by the file size reducer 205 in which files are smaller in size than those of the reduced-size training data 217. Stages C and D thus can be performed an additional time(s) after the second training event is completed for completion of a third training event. Training the CNN 207 in multiple stages on successively smaller files provides a better-performing trained CNN than one trained initially and only on smaller files.

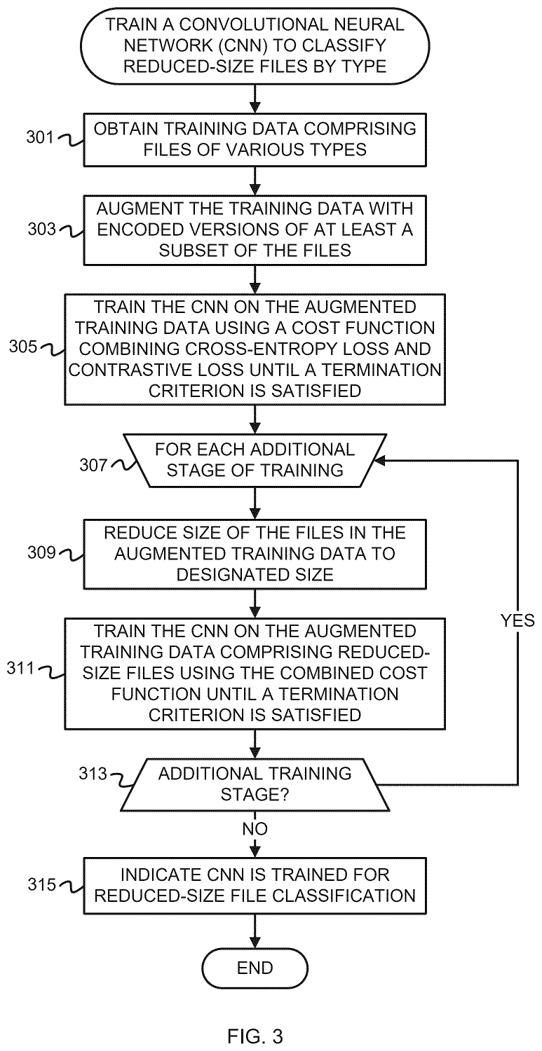

FIGS. 3-5 are flowcharts of example operations. The example operations are described with reference to a reduced-size file classification service (“the service”) and a reduced-size file classifier trainer (“the classifier trainer”) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for training a CNN to classify reduced-size files by type. The CNN that is trained comprises a KAN layer in lieu of a traditional fully connected layer as one of its hidden layers. Generally, the KAN layer will receive the outputs of a pooling layer (e.g., a global max pooling layer) as inputs and provide its outputs as inputs to a softmax layer. Additionally, architecture of the CNN can depend on the deployment environment in which the CNN operates. For instance, if the CNN is deployed to execute on a hardware appliance (e.g., a hardware firewall), the CNN may have a smaller number of neurons due to storage constraints of the hardware. If the CNN is deployed in a virtual or cloud-based environment, the CNN may have a larger number of neurons relative to the hardware appliance implementation due to more flexible storage space availability and/or more cloud computing resource availability.

At block 301, the classifier trainer obtains training data comprising files of various types. Examples of file types that can be included in the training data include scripts (e.g., .py files, js files, etc.) and documents (e.g., Portable Document Format (PDF) files, .doc/.docx files, etc.). The files in the training data have been labelled according to their type. File types may be defined at a higher level of granularity, such as based on categories of files to which various file extensions can correspond. To illustrate, .py and .js files can both be labelled as scripts. The files may instead be labelled by type at a lower level of granularity in other examples, such as based on file types corresponding to a file extension (e.g., the label “PDF” for PDF files, “doc/docx” for .doc/.docx files, etc.).

At block 303, the classifier trainer augments the training data with encoded versions of at least a subset of the files. The classifier encodes at least a subset of the files in the set of training data to generate encoded versions thereof so that the CNN is trained for classifying both encoded and non-encoded reduced-size files by type. Selection of the subset of files to generate encoded versions of can be random, such as based on randomly selecting N files from the training data, where N is a configured value of the classifier trainer or parameter value. For each of the files selected for encoding, the classifier trainer encodes the file with one or more encoding techniques to generate a corresponding one or more encoded versions thereof. Encoding algorithms or standards that the classifier trainer employs can include Base64 encoding and/or UTF-8. For instance, the classifier trainer can encode each of the selected files to Base64 format and/or UTF-8 format. The classifier trainer adds each encoded file and corresponding label to the set of training data to yield augmented training data.

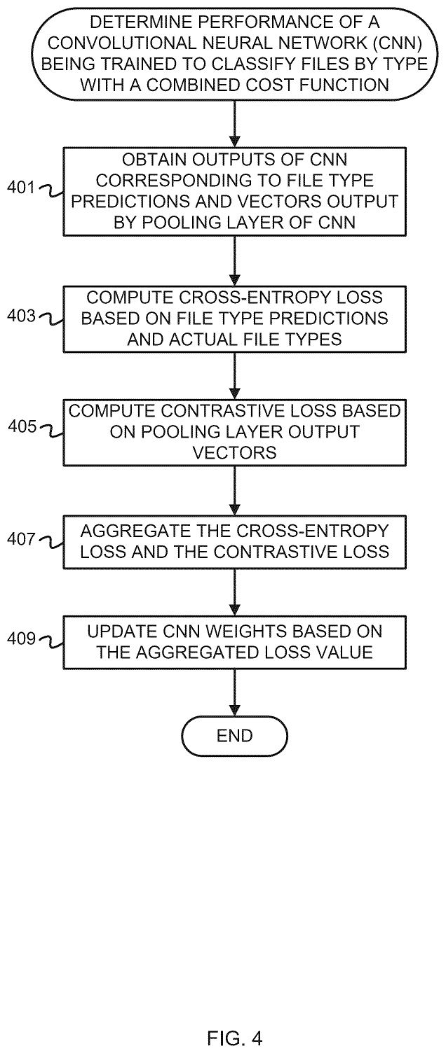

At block 305, the classifier trainer trains the CNN on the augmented training data using a cost function that combines cross-entropy loss and contrastive loss until a termination criterion is satisfied. For each of the files in the augmented training data, the classifier trainer inputs the file into the CNN and obtains a probability vector as output. The classifier trainer also extracts (e.g., copies) a vector output by a pooling layer of the CNN for each file. For each file for which the CNN outputs a prediction, the classifier trainer evaluates performance of the CNN based on the cost function that combines (e.g., aggregates) cross-entropy and contrastive loss computations. Cross-entropy loss is computed based on the probability vectors and actual file type labels, while contrastive loss is computed based on the outputs of the pooling layer for pairs of files having the same labelled type and for pairs having different labelled types. The classifier trainer then combines the resulting cross-entropy loss and contrastive loss values computed for the file. Computation of cost with the combined cost function is described in additional detail in reference to FIG. 4. The classifier trainer adjusts weights of the CNN based on the computed cost, where an adjustment of weights can be performed after completion of each training epoch or after each batch/mini-batch based on aggregating (e.g., summing) the computed cost values across the batch or mini-batch of training data. Training with cost computation using the combined cost function and updating of weights occurs in this manner until at least a first termination criterion is satisfied. The termination criterion can be a cost criterion such that training can be considered complete when the computed cost is reduced to a designated value, a number of training epochs has been completed, etc.

At block 307, the classifier trainer begins additional stages of training for the trained CNN. The additional training stages serve to fine-tune the CNN for the capability of classifying files of reduced sizes. Training the CNN on the original files initially before fine-tuning the trained CNN for classification of smaller files through an additional stage(s) of training leads to greater accuracy in classifications than training the CNN on reduced-size files initially. Multiple additional stages of training can be performed using successively smaller versions of the files included in the augmented training data.

At block 309, the classifier trainer reduces the size of the files in the augmented training data to a designated size. The classifier trained has been configured with indications of one or more sizes to which to reduce files used for training. The classifier trainer reduces the size of each of the files included in the augmented training data to the designated size, such as by truncating each file to shorten the file length to the designated size. If multiple sizes are maintained, the size to which the classifier trainer reduces the files can be dependent on the round of training being performed; to illustrate, the classifier trainer can truncate the files to their first N bytes during a first training round and to their first M bytes during a second training round, where N>M. If the original size of a file is smaller than the designated size for size reduction, the classifier trainer may maintain the file of its original size in the augmented training data.

At block 311, the classifier trainer trains the CNN on the augmented training data comprising reduced-size files using the combined cost function until a termination criterion is satisfied. Training of the CNN on the reduced-size versions of the files in the augmented training data set is performed as similarly described above in reference to block 305. However, the classifier trainer may be configured with a different termination criterion than that used for the initial training round with the files of their original sizes.

At block 313, the classifier trainer determines if there is an additional training stage remaining. The classifier trainer has been configured to perform a designated number of stages of training in addition to the initial round of training for fine-tuning of the CNN for classifying files of reduced sizes. The number of training stages may be dependent on whether the trained CNN is to be deployed to a virtual/cloud-based environment or a hardware environment for execution. If there is another training stage remaining, operations continue at block 307. If not, operations continue at block 315.

At block 315, the classifier trainer indicates that the CNN is trained for reduced-size file classification. The classifier trainer can generate a notification, alert, etc. indicating that the CNN has been trained and can be deployed for file type classification operations.

FIG. 4 is a flowchart of example operations for determining performance of a CNN being trained to classify files by type with a combined cost function. Performance determination with the combined cost function can be performed during initial training of the CNN on files of their original size and during further training of the CNN with reduced-size versions of the files. This example assumes that cost computation is performed after obtaining predictions for each batch/mini-batch of training data or after each epoch of training, though operations can be performed at least in part after each output is obtained from the CNN.

At block 401, the classifier trainer obtains outputs of the CNN corresponding to file type predictions and vectors output by a pooling layer of the CNN. The classifier trainer obtains probability vectors as outputs of the CNN that correspond to each file provided as input and extracts a vector output by the pooling layer of the CNN for each file.

At block 403, the classifier trainer computes cross-entropy loss based on the file type predictions and corresponding actual file types. The classifier trainer computes the cross-entropy loss based on a vector of values indicating the actual file type of the file corresponding to its label and the probabilities of each file type prediction indicated in the CNN output. Cross-entropy loss can be computed for each training example and aggregated across training examples once the batch/mini-batch or epoch has been completed.

At block 405, the classifier trainer computes contrastive loss based on the pooling layer output vectors. The classifier trainer computes the contrastive loss based on the vectors output by the pooling layer of the CNN and actual file type labels associated therewith, where contrastive loss is computed with pairs of vectors corresponding to the same actual file type and corresponding to different actual file types. Either Euclidean distance or cosine similarity can be used to compute contrastive loss between pairs of these vectors.

At block 407, the classifier trainer aggregates the cross-entropy loss and the contrastive loss. The classifier trainer can add, average, or otherwise combine the cross-entropy loss and contrastive loss to generate a combined loss value.

At block 409, the classifier trainer updates the weights of the CNN based on the aggregated loss value. The classifier trainer can update the weights according to backpropagation and/or with a gradient descent algorithm.

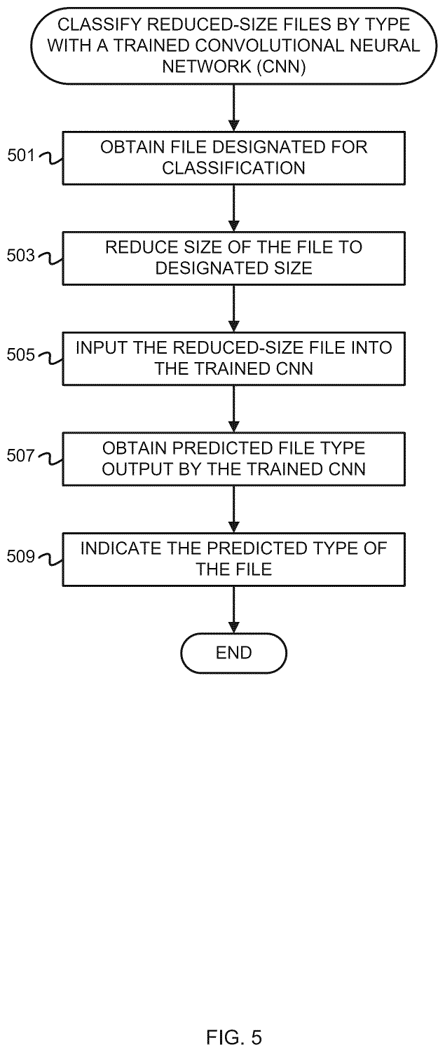

FIG. 5 is a flowchart of example operations for classifying reduced-size files by type with a trained CNN. The trained CNN has been trained as described above to classify reduced-size (e.g., truncated) files by type. The trained CNN also is assumed to have the architecture described above.

At block 501, the service obtains a file designated for classification. The file may have been detected by a cybersecurity appliance (e.g., a firewall), for instance.

At block 503, the service reduces the size of the file to a designated size. Often, the service will truncate the file to the designated size to reduce its size. In this case, the classifier trainer truncates the file to the designated size, such as to its first N bytes (e.g., the first 1500 bytes or 3000 bytes). In other examples, the service can truncate the file to its last N bytes, middle N bytes, or similar truncations. The service has been configured with an indication of the size to which to truncate or otherwise reduce the file.

At block 505, the service inputs the reduced-size file into the trained CNN. An output of the trained CNN, which the service obtains at block 507, indicates a vector comprising probabilities of the reduced-size file corresponding to each of a plurality of possible types. Examples of file types that the CNN has been trained to predict and thus that may have corresponding probabilities in the output vector based on input files include scripts, images, and documents, among others.

At block 509, the service indicates the predicted type of the file. The service determines the file type that corresponds to a maximum probability indicated in the output vector. The service can generate a notification indicating the predicted type of the file and/or attach a label, tag, etc. to the file with an indication of its predicted type. The service can also indicate the probability associated with the type prediction. Implementations may alternatively or additionally forward the file to a malware detector corresponding to the predicted file type for analysis to determine if the file comprises malware.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

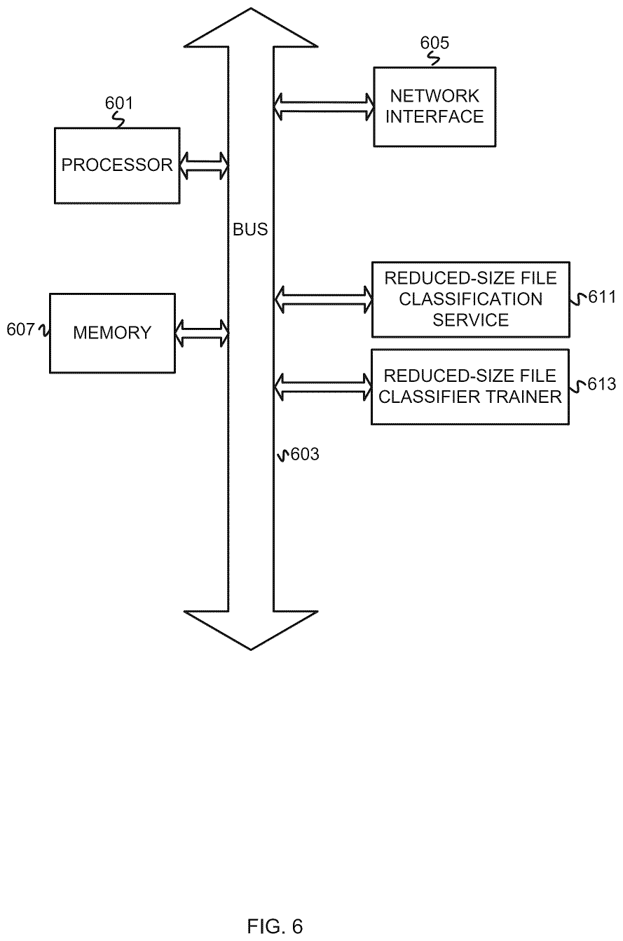

FIG. 6 depicts an example computer system with a reduced-size file classification service and a reduced-size file classifier trainer. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes reduced-size file classification service 611 and reduced-size file classifier trainer 613. The reduced-size file classification service 611 classifies reduced-size files, or files that have been reduced in size (e.g., truncated), according to their predicted type by leveraging a CNN trained for this task. The reduced-size file classifier trainer 613 trains the CNN to classify files of reduced sizes by type based partly on determining error with a cost function that combines cross-entropy loss and contrastive loss. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
based on detecting a first file, reducing a size of the first file to a designated size to generate a reduced-size file;
predicting a type of the first file based on inputting the reduced-size file into a convolutional neural network (CNN),
wherein the CNN has been trained to classify reduced-size files of the designated size as corresponding to one of a plurality of file types,
wherein the CNN comprises a first hidden layer corresponding to a Kolmogorov-Arnold Network (KAN) layer; and
indicating the predicted type of the first file based on an output of the CNN.

2. The method of claim 1, further comprising training the CNN, wherein training the CNN comprises training the CNN on a first set of training data comprising a plurality of files until a first training criterion is satisfied, wherein each of the plurality of files is labelled as corresponding to one of the plurality of file types.

3. The method of claim 2, further comprising, based at least partly on determining that the first training criterion is satisfied, training the CNN with a second set of training data comprising a plurality of reduced-size files, wherein each of the plurality of reduced-size files corresponds to one of the plurality of files and is labelled as corresponding to one of the plurality of file types, wherein inputting the reduced-size file into the CNN comprises inputting the reduced-size file into the CNN that has been trained on the second set of training data.

4. The method of claim 2, further comprising augmenting the first set of training data to generate an augmented set of training data, wherein augmenting the set of training data comprises, for each file of at least a subset of the plurality of files, encoding or obfuscating the file and adding the encoded or obfuscated file to the first set of training data, wherein training the CNN comprises training the CNN with the augmented set of training data.

5. The method of claim 2, wherein training the CNN comprises,
for each of the plurality of files and corresponding output of the CNN indicating a predicted one of the plurality of file types, computing loss based on the predicted file type and actual file type to which the first file corresponds based on a cost function that combines a cross-entropy loss and a contrastive loss; and
updating weights of layers of the CNN based on the computed loss.

6. The method of claim 5, wherein calculating loss based on the cost function that aggregates the cross-entropy loss and the contrastive loss comprises,
computing the cross-entropy loss based on the predicted file type and actual file type;
computing the contrastive loss based on an output of a second hidden layer of the CNN and the actual file type; and
aggregating the cross-entropy loss and the contrastive loss, wherein updating weights of the layers of the CNN based on the aggregated cross-entropy loss and contrastive loss.

7. The method of claim 6, wherein the second hidden layer of the CNN is a pooling layer of the CNN.

8. The method of claim 1, wherein reducing the size of the first file comprises truncating the first file to the designated size.

9. The method of claim 1, wherein the CNN has been trained to classify reduced-size scripts by script type, wherein indicating the predicted type of the first file comprises indicating the predicted script type of the first file.

10. One or more non-transitory machine-readable media having program code stored thereon, the program code comprising instructions to:
based on designation of a first file for classification, truncate the first file to a designated size to generate a truncated file;
predict a type of the first file based on input of the truncated file into a convolutional neural network (CNN),
wherein the CNN has been trained to classify truncated files of the designated size as corresponding to one of a plurality of file types,
wherein the CNN comprises a first hidden layer corresponding to a Kolmogorov-Arnold Network (KAN) layer; and
indicate the predicted type of the first file based on an output of the CNN.

11. The non-transitory machine-readable media of claim 10, wherein the program code further comprises instructions to train the CNN, wherein the instructions to train the CNN comprise instructions to train the CNN with a first set of training data comprising a plurality of files, wherein each of the plurality of files is labelled as corresponding to one of the plurality of file types.

12. The non-transitory machine-readable media of claim 11, wherein the instructions to train the CNN further comprise instructions to,
based on completion of training the CNN with the first set of training data, train the CNN with a second set of training data comprising a plurality of truncated files,
wherein each of the plurality of truncated files corresponds to one of the plurality of files,
wherein the instructions to input the truncated file into the CNN comprises inputting the truncated file into the CNN that has been trained with the second set of training data.

13. The non-transitory machine-readable media of claim 11, wherein the instructions to train the CNN further comprise instructions to, for each of the plurality of files and corresponding output of the CNN indicating a predicted one of the plurality of file types, compute loss based on the predicted file type and actual file type to which the first file corresponds based on a cost function that aggregates a cross-entropy loss and a contrastive loss.

14. An apparatus comprising:
a processor; and
a machine-readable medium having instructions stored thereon that are executable by the processor to cause the apparatus to,
reduce a size of a first file indicated for classification to a designated size to generate a reduced-size file;
predict a type of the first file based on input of the reduced-size file into a convolutional neural network (CNN),
wherein the CNN has been trained to classify reduced-size files of the designated size as corresponding to one of a plurality of file types,
wherein the CNN comprises a first hidden layer corresponding to a Kolmogorov-Arnold Network (KAN) layer; and
indicate the predicted type of the first file based on an output of the CNN.

15. The apparatus of claim 14, further comprising instructions executable by the processor to cause the apparatus to train the CNN, wherein the instructions to train the CNN comprise instructions to train the CNN on a first set of training data comprising a plurality of files until a first training criterion is satisfied, wherein each of the plurality of files is labelled as corresponding to one of the plurality of file types.

16. The apparatus of claim 15, further comprising instructions executable by the processor to cause the apparatus to,
based at least partly on a determination that the first training criterion is satisfied, fine-tune the CNN with a second set of training data comprising a plurality of reduced-size files,
wherein each of the plurality of reduced-size files corresponds to one of the plurality of files,
wherein the instructions executable by the processor to cause the apparatus to input the reduced-size file into the CNN comprise executable by the processor to cause the apparatus to input the reduced-size file into the CNN that has been trained on the second set of training data.

17. The apparatus of claim 15, wherein the instructions executable by the processor to cause the apparatus to train the CNN comprise instructions executable by the processor to cause the apparatus to,
for each of the plurality of files and corresponding output of the CNN indicating a predicted one of the plurality of file types, compute loss with a cost function that combines a cross-entropy loss and a contrastive loss; and
update weights of layers of the CNN based on the computed loss.

18. The apparatus of claim 17, wherein the instructions executable by the processor to cause the apparatus to compute loss based on the cost function that combines the cross-entropy loss and the contrastive loss comprise instructions executable by the processor to cause the apparatus to,
compute the cross-entropy loss based on the predicted file type and actual file type;
compute the contrastive loss based on an output of a second hidden layer of the CNN and the actual file type; and
aggregate the cross-entropy loss and the contrastive loss, wherein the computed loss comprises the aggregated cross-entropy loss and the contrastive loss.

19. The apparatus of claim 15, further comprising instructions executable by the processor to cause the apparatus to augment the first set of training data to generate an augmented set of training data,
wherein the instructions executable by the processor to cause the apparatus to augment the set of training data comprise instructions executable by the processor to cause the apparatus to, for each file of at least a subset of the plurality of files, encode or obfuscate the file and add the encoded or obfuscated file to the first set of training data,
wherein the instructions executable by the processor to cause the apparatus to train the CNN comprise instructions executable by the processor to cause the apparatus to train the CNN with the augmented set of training data.

20. The apparatus of claim 14, wherein the instructions executable by the processor to cause the apparatus to reduce the size of the first file comprise instructions executable by the processor to cause the apparatus to truncate the first file to the designated size.
